(19) United States
(12) Patent Application Publication
(10) Pub. No.: US 2016/0190527 A1
(43) Pub. Date: Jun. 30, 2016

(54) BATTERY MODULE AND MANUFACTURING METHOD THEREOF

(71) Applicant: J-TEK INCORPORATION, Hsinchu City (TW)

(72) Inventors: Ming-Da HSU, Hsinchu City (TW); Jui-Yi CHIEN, Hsinchu City (TW); Tzone-Yuan Kuo, Hsinchu City (TW)

(21) Appl. No.: 14/986,249

(22) Filed: Dec. 31, 2015

(30) Foreign Application Priority Data
Dec. 31, 2014 (TW) 103146508

(51) Int. Cl. H01M 2/10; H01M 10/04; H01M 2/34

(52) U.S. Cl. CPC H01M 2/1077; H01M 2/34; H01M 10/0422; H01M 2200/103; H01M 2220/20

(57) ABSTRACT

A manufacturing method of a battery module. Firstly, at least two identical electrode metal plates including a frame portion and a metal extending portion are formed by punching. Then, a frame is provided to cover the electrode metal plate to form the integrated battery core frame, and the frame includes the exposed portions to expose the frame portion and the metal extending portion. Thereafter, the electrode connection portion of the metal extending portion is removed. Then, the conductive wire or the chip fuse is arranged on the frame portion of the electrode metal plate for touching the electrode of the battery core and the electrode extending portion of the metal extending portion. Thereafter, a plurality of battery cores and the integrated battery core frame are assembled to have the first electrode and the second electrode of the battery cores touching the electrode touching portions. Finally, the electrode touching portion is connected to the first electrode by welding.

This application claims the benefit of Taiwan Patent Application Serial No. 103146508, filed Dec. 31, 2014, the subject matter of which is incorporated herein by reference.

### BACKGROUND OF INVENTION

1. Field of the Invention

The present invention is related to a battery module and a manufacturing method thereof, and more particularly related to the battery module with the same electrode metal plates and the manufacturing method thereof.

2. Description of the Prior Art

Because of the increasing price of fossil-based fuel and the rising awareness of environment protection, many alternative energy sources, such as bio-diesel, fuel cell, solar energy or wind energy, had been developed for vehicles. Among the various alternative fuel vehicles, electric car is still the main trend in present. The battery module for the electric car usually includes a plurality of battery cores, a cathode metal electrode plate, and an anode metal electrode plate to connect the battery cores in serial or parallel according to the need.

However, during the manufacturing process of the existed battery module, it is usually needed to use two different molds specifically for manufacturing the cathode metal electrode plate and the anode metal electrode plate, and thus the manufacturing cost is high. In addition, the battery core may have combustible gas leakage at the cathode when the battery core is operated under the abnormal condition, and it is difficult to have the combustible gas dissipated from the cathode under the restriction of the existed cathode metal plate. Accordingly, an improvement for the battery module technology is desirable.

### SUMMARY OF THE INVENTION

The battery module in present has the problem of high manufacturing cost due to the two different molds specifically for manufacturing the two metal electrode plates and the problem of high risk because of the difficulty to dissipate the gas generated in the battery module. Accordingly, a battery module and a manufacturing method thereof is provided in the present invention, which features the positive electrode plate and the negative electrode plate of the same design and removes some material from the positive electrode plate connecting to the positive electrode, such that the problems of high manufacturing cost and high risk can be resolved.

As mentioned, in accordance with the object of the present invention, a manufacturing method of battery module utilized for manufacturing a batter module is provided. The manufacturing method comprises the steps of: (a) forming a first electrode metal plate and a second electrode metal plate by punching, the first electrode metal plate including a first frame portion and a plurality of first metal extending portions, each of the first metal extending portions being extended from the first frame portion and including a first electrode connecting portion and a first electrode touching portion, wherein the first electrode connecting portion is connected to the first frame portion, and the first electrode touching portion is connected to the first electrode connecting portion; and the second electrode metal plate including a second frame portion and a plurality of second metal extending portions, each of the second metal extending portions being extended from the second frame portion and including a second electrode connecting portion and a second electrode touching portion, wherein the second electrode connecting portion is connected to the second frame portion, and the second electrode touching portion is connected to the second electrode connecting portion; (b) providing a first frame and a second frame, having the first frame covering the first electrode metal plate to form a first integrated battery core frame and having the second frame covering the second electrode metal plate to form a second integrated battery core frame, the first frame including a plurality of first battery core allocation portions and a plurality of first exposed portions, the first frame portion being exposed from the plurality of the first exposed portions, and the plurality of the first metal extending portions being exposed from the plurality of the first exposed portions respectively, the second frame including a plurality of second battery core allocation portions and a plurality of second exposed portions, the second frame portion being exposed from the plurality of the second exposed portions and the second extending portions being exposed from the plurality of the second exposed portions respectively; (c) removing the first electrode connection portion or a first electrode extending portion of the first metal extending portion; (d) when the first electrode connection portion is removed in the step (c), arranging a conductive wire or a chip fuse on the first frame portion and the first electrode extending portion of the first metal extending portion to have the first frame portion connected to the first electrode extending portion; (e) assembling a plurality of battery cores, the first integrated battery core frame, and the second integrated battery core frame to have the plurality of the battery cores located in the plurality of the first battery core allocation portions and the plurality of the second battery core allocation portions respectively and have a first electrode of the plurality of the battery cores touching the first electrode touching portion and have a second electrode of the plurality of the battery cores touching the second electrode touching portion; and (f) welding the first electrode touching portion and the first electrode of the plurality of the battery cores to have the first electrode touching portion electrically connected to the first electrode. Wherein the first electrode metal plate and the second electrode metal plate are of the same structure, and the first frame and the second frame are of the same structure. When the first electrode extending portion is removed in the above mentioned step, the plurality of the battery cores, the first integrated battery core frame, and the two integrated battery core frame are assembled directly and then the first electrode touching portion is connected to the first electrode of the plurality of the battery cores by welding.

In accordance with an embodiment of the present invention, the first electrode touching portion is further connected to the first electrode extending portion, and in the last step, the first electrode extending portion is removed. The first frame comprises a first frame body and a first plate, the first frame body includes the plurality of the first battery core allocation portions, the first plate is connected to the first frame body and includes the plurality of the first exposed portions, the second frame comprises a second frame body and a second plate, the second frame body includes the plurality of the second battery core allocation portions, the second plate is connected to the second frame body and includes the plurality of the second exposed portions. The first frame body and the first plate are formed on two sides of the first electrode metal plate by an in-mold injection process, and the second frame body and the second plate are formed on two sides of the second electrode metal plate by an in-mold injection process.

In accordance with an embodiment of the present invention, the first frame and the second frame are made of plastic material, the conductive wire is a metal wire, at least two fixers connected to the first integrated battery core frame and the second integrate battery core frame are used to fix the first integrated battery core frame and the second integrated battery core frame, and the first electrode is a positive electrode and the second electrode is a negative electrode.

In addition, in accordance with the object of the present invention, a battery module is also provided in the present invention. The battery module comprising a first integrated battery core frame, a second integrated battery core frame, and a plurality of battery cores. The first integrated battery core frame includes a first frame and a first electrode metal plate. The first frame includes a plurality of first battery core allocation portions and a plurality of first exposed portions. The plurality of the first exposed portions is connected to the plurality of the first battery core allocation portions. The first electrode metal plate is covered by the first frame, and includes a first frame portion and a plurality of first metal extending portions. The first frame portion is exposed from the plurality of the first exposed portions. Each of the first metal extending portions is extended from the first frame portion, exposed from the plurality of the first exposed portions respectively, and includes a first electrode touching portion and a first electrode extending portion. The first electrode extending portion is electrically connected to the first frame portion through a conductive wire or a chip fuse. The second integrated battery core frame includes a second frame and a second electrode metal plate. The second frame includes a plurality of second battery core allocation portions and a plurality of second exposed portions. The plurality of the second exposed portions is connected to the plurality of the second battery core allocation portions. The second electrode metal plate is covered by the second frame, and includes a second frame portion and a plurality of second metal extending portions. The second frame portion is exposed from the plurality of the second exposed portions. Each of the second metal extending portions is extended from the second frame portion, exposed from the plurality of the second exposed portions respectively, and includes a second electrode connection portion and a second electrode touching portion. The second electrode connection portion is connected to the second frame portion and the second electrode touching portion is connected to the second electrode connection portion. The plurality of the battery cores is partially located in the plurality of the first battery core allocation portions and the plurality of the second battery core allocation portions. A first electrode of the plurality of the battery cores touches the first electrode touching portion of the plurality of the first metal extending portions, and a second electrode of the plurality of the battery cores touches the plurality of the second electrode touching portions. The first electrode metal plate and the second electrode metal plate are of the same structure, and the first frame and the second frame are of the same structure.

In accordance with an embodiment of the present invention, the first frame comprises a first frame body and a first plate, the first frame body includes the plurality of the first battery core allocation portions, the first plate is connected to the first frame body and includes the plurality of the first exposed portions, the second frame comprises a second frame body and a second plate, the second frame body includes the plurality of the second battery core allocation portions, the second plate is connected to the second frame body and includes the plurality of the second exposed portions. In addition, the first frame and the second frame are made of plastic material, the conductive wire is a metal wire, the battery module further includes at least two fixers connected to the first integrated battery core frame and the second integrated battery core frame for fixing the first integrated battery core frame and the second integrated battery core frame, and the first electrode is a positive electrode and the second electrode is a negative electrode.

By using the technology of the battery module and the manufacturing method thereof provided in the present invention, only one mold is needed for manufacturing the positive electrode plate and the negative electrode plate because they are of the same design and it is only needed to remove the electrode connection portion from the positive electrode plate connected to the positive electrode but use a conductive wire instead. In addition, the gas generated in the battery module can be dissipated through the exposed portion effectively. Therefore, the manufacturing cost and the risk can be reduced.

### BRIEF DESCRIPTION OF THE DRAWINGS

The present invention will now be specified with reference to its preferred embodiment illustrated in the drawings, in which:

FIG. 1 is a flow chart showing a manufacturing method of a battery module in accordance with a preferred embodiment of the present invention;

FIG. 2 is a 3D schematic view of the first electrode metal plate in accordance with a preferred embodiment of the present invention;

FIG. 3 is a 3D schematic view of the first frame body in accordance with a preferred embodiment of the present invention;

FIG. 4 is a 3D schematic view of the first plate in accordance with a preferred embodiment of the present invention;

FIG. 5 is a 3D schematic view of the first frame in accordance with a preferred embodiment of the present invention;

FIG. 6 is a 3D schematic view of the first frame portion and the first electrode extending portion with the conductive wire arranged thereon;

FIG. 7 is an explosive schematic view of the assembly of a plurality of battery cores, the first integrated battery core frame, and the second integrated battery core frame in accordance with a preferred embodiment of the present invention;

FIG. 8 is a 3D schematic view of the battery module in accordance with a preferred embodiment of the present invention;

FIG. 8A is an enlarged view of a portion of the battery module in accordance with a preferred embodiment of the present invention;

FIG. 9 is a 3D schematic view of the first frame portion and the first electrode extending portion with the chip fuse arranged thereon in accordance with another embodiment of the present invention; and

FIG. 10 is a 3D schematic view showing the first frame portion and the first metal extending portion with the first electrode extending portion being removed in accordance with another embodiment of the present invention.

### DESCRIPTION OF THE PREFERRED EMBODIMENT

There are various embodiments of the battery module and the manufacturing method thereof provided in the present invention, which are not repeated hereby. A preferred embodiment is mentioned in the following paragraphs as an example.

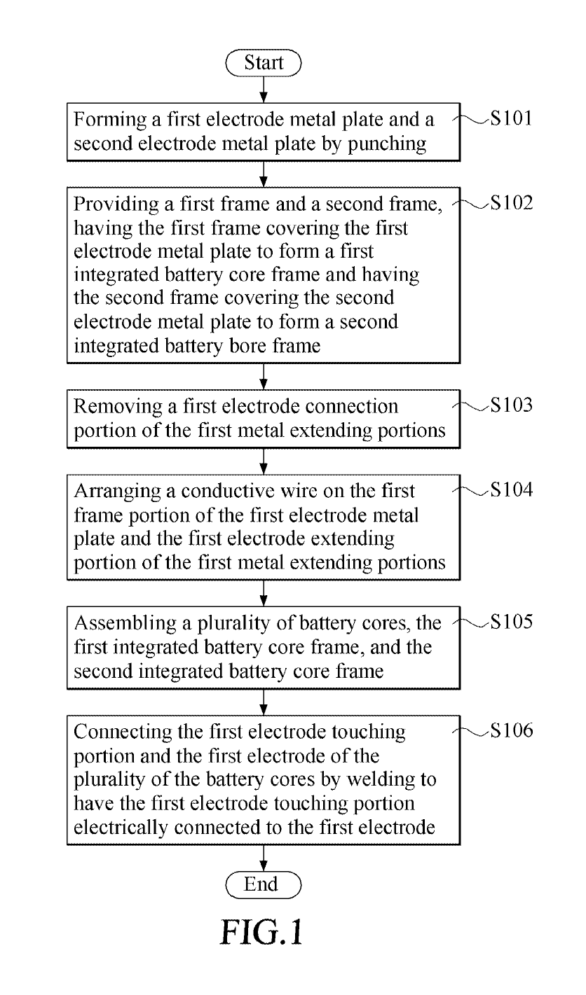

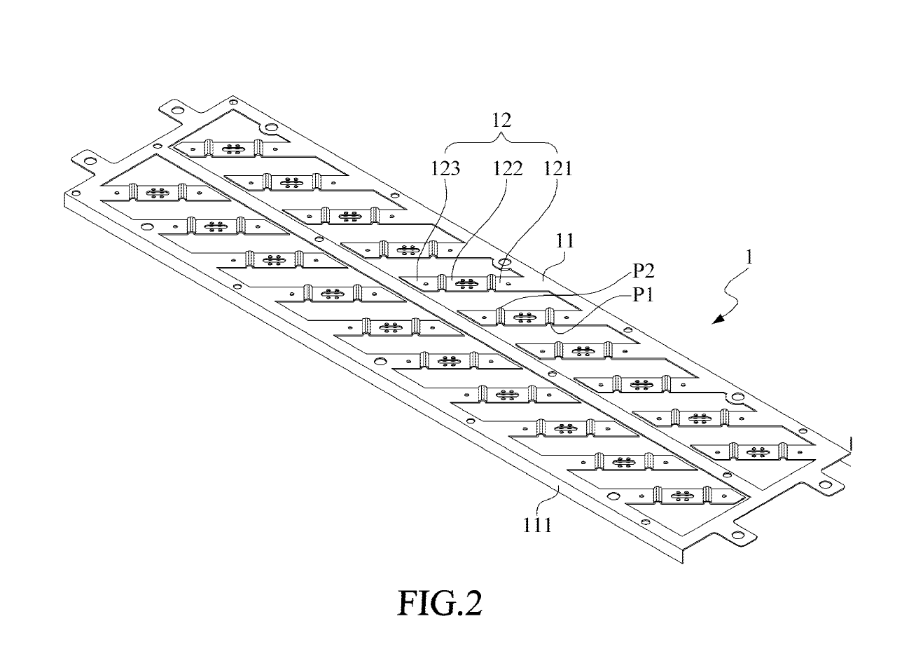

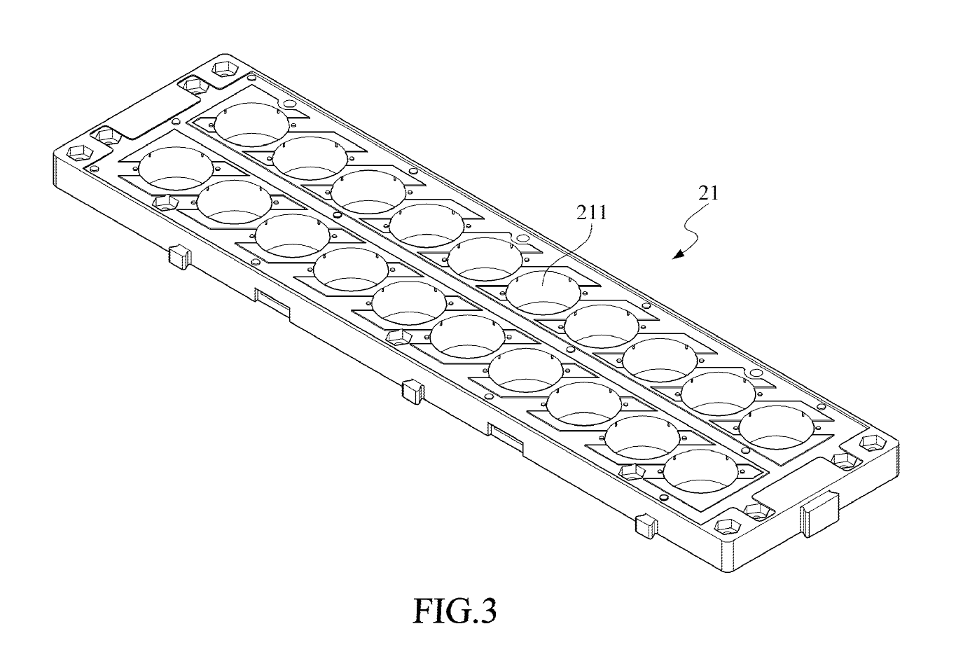

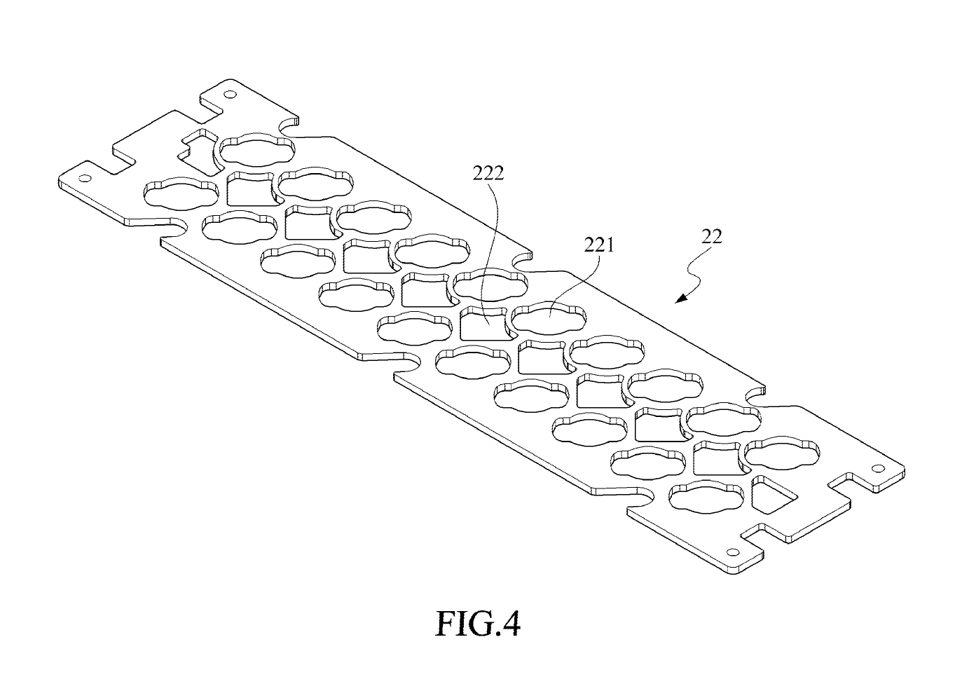

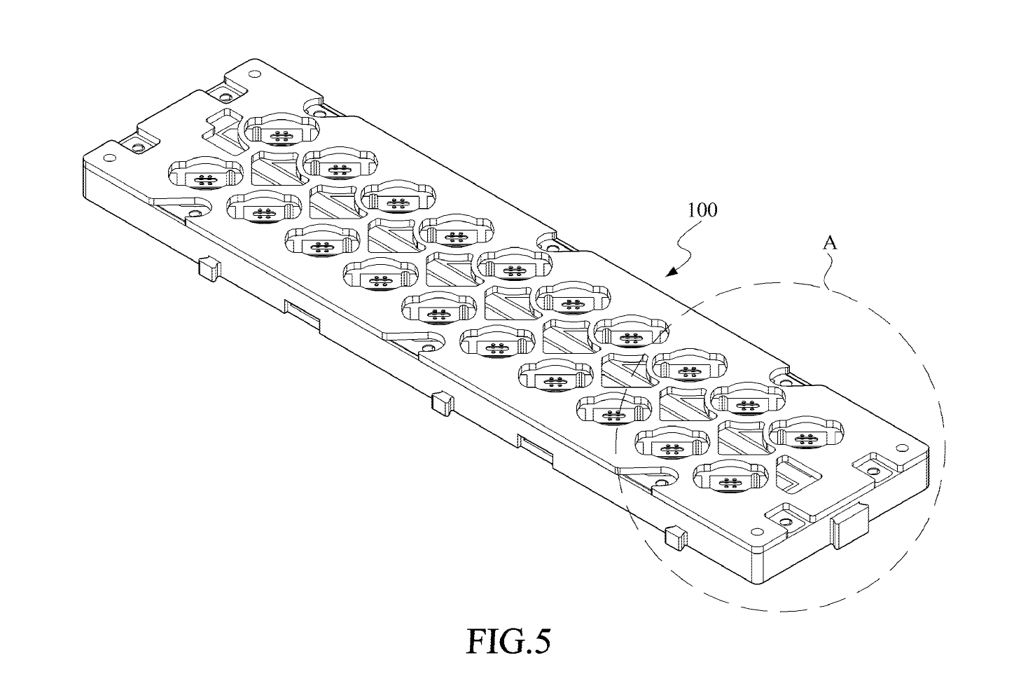

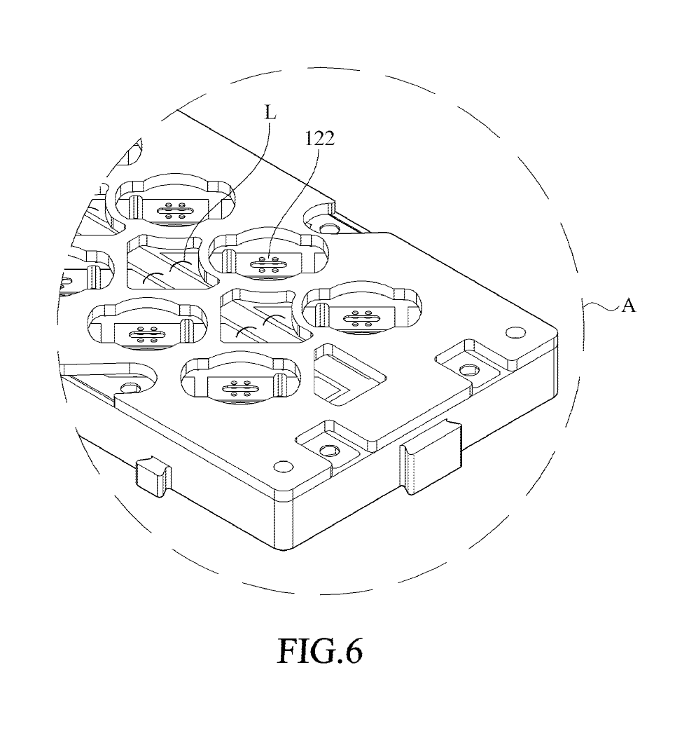

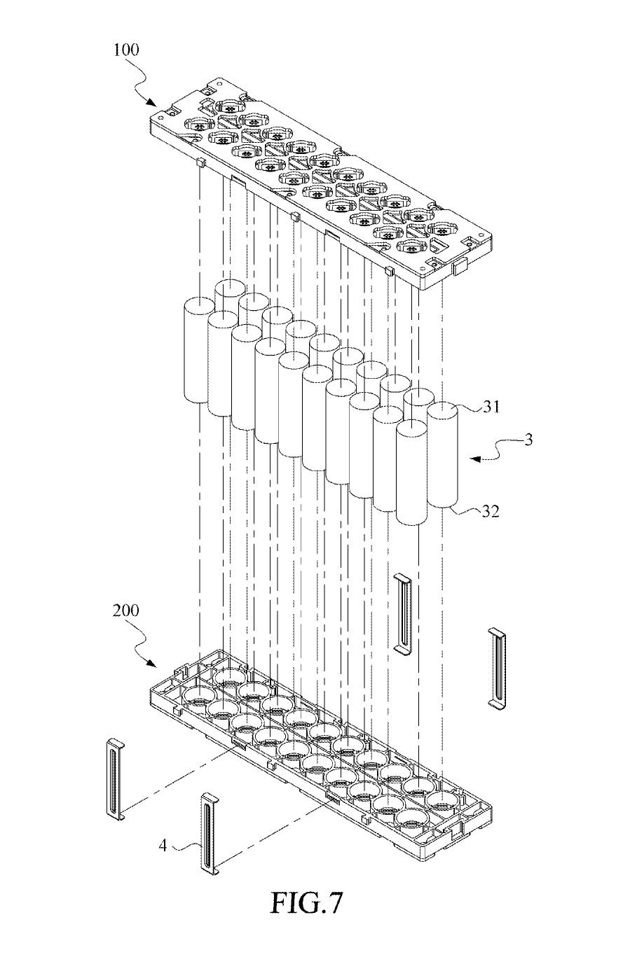

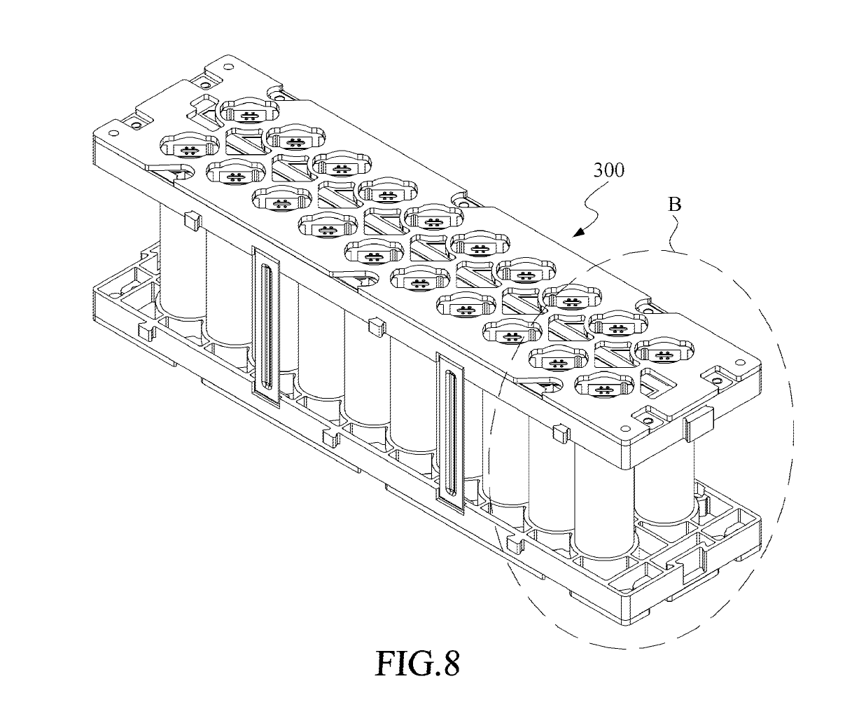

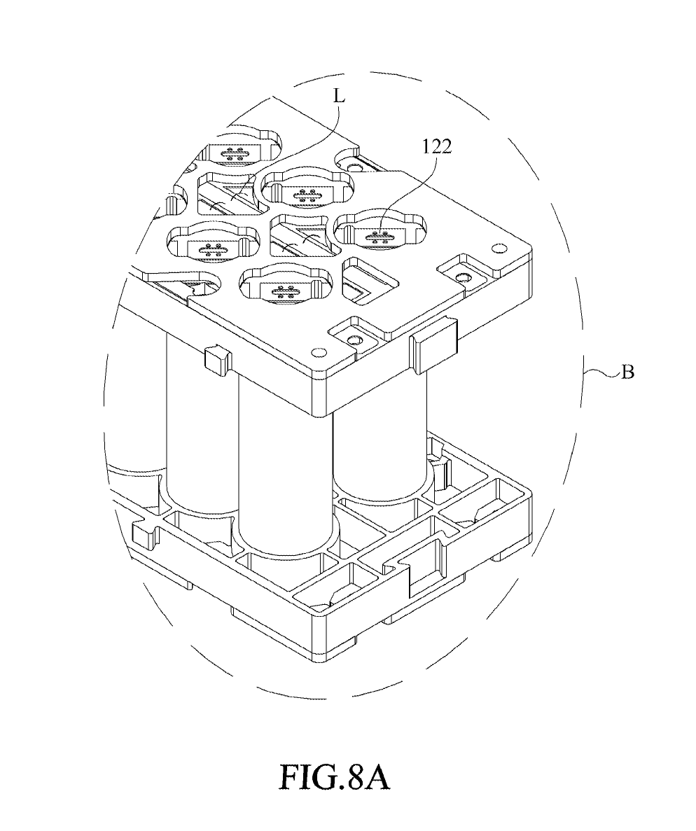

Please refer to FIG. 1 to FIG. 8A, wherein FIG. 1 is a flow chart showing a manufacturing method of a battery module in accordance with a preferred embodiment of the present invention, FIG. 2 is a 3D schematic view of the first electrode metal plate in accordance with a preferred embodiment of the present invention, FIG. 3 is a 3D schematic view of the first frame body in accordance with a preferred embodiment of the present invention, FIG. 4 is a 3D schematic view of the first plate in accordance with a preferred embodiment of the present invention, FIG. 5 is a 3D schematic view of the first frame in accordance with a preferred embodiment of the present invention, FIG. 6 is a 3D schematic view of the first frame portion and the first electrode extending portion with the conductive wire arranged thereon, FIG. 7 is an explosive schematic view of the assembly of a plurality of battery cores, the first integrated battery core frame, and the second integrated battery core frame in accordance with a preferred embodiment of the present invention, FIG. 8 is a 3D schematic view of the battery module in accordance with a preferred embodiment of the present invention, and FIG. 8A is an enlarged view of a portion of the battery module in accordance with a preferred embodiment of the present invention. As shown, the manufacturing method in accordance with a preferred embodiment of the present invention is to manufacture the battery module 100 as shown in FIG. 7. The method comprises the steps of:

Step S101: forming a first electrode metal plate and a second electrode metal plate by punching;

Step S102: providing a first frame and a second frame, having the first frame covering the first electrode metal plate to form a first integrated battery core frame and having the second frame covering the second electrode metal plate to form a second integrated battery bore frame;

Step S103: removing a first electrode connection portion of the first metal extending portions;

Step S104: arranging a conductive wire on the first frame portion of the first electrode metal plate and the first electrode extending portion of the first metal extending portions;

Step S105: assembling a plurality of battery cores, the first integrated battery core frame, and the second integrated battery core frame; and

Step S106: connecting the first electrode touching portion and the first electrode of the plurality of the battery cores by welding to have the first electrode touching portion electrically connected to the first electrode.

After the manufacturing process is started, the step S101 is carried out to form a first electrode metal plate 1 and a second electrode metal plate (not shown) by punching. In this step, the first electrode metal plate 1 and the second electrode metal plate by using the punching process. It should be noted that the second electrode metal plate and the first electrode metal plate are of the same structure, and thus only the first electrode metal plate 1 is shown in the figures of the present invention.

As shown in FIG. 2, the first electrode metal plate 1 includes a first frame portion 11 and a plurality of first metal extending portions 12 (only one of them is labeled in the figure). The first frame portion 11 includes an outer frame and an inner frame (not labeled in the figure) to compose a “ [symbol] ” shaped structure. The first metal extending portions 12 are extended from the first frame portion 11, and connected to the first frame portion 11 and arranged at equal interval on the first frame portion 11. Concretely speaking, the first metal extending portion 12 includes a first electrode connection portion 121, a first electrode touching portion 122, and a first electrode extending portion 123. The first electrode connection portion 121 is connected to the first frame portion 11. The first electrode touching portion 122 is connected to the first electrode connection portion 121, the first electrode extending portion 123 is connected to the first electrode touching portion 122, and the first electrode extending portion 123 is away from the central portion (the inner frame) of the first frame portion 11 by an adequate distance (not shown) and remains planar. That is, the distance cannot be too large or too small, and the first electrode extending portion 123 and the first frame portion 11 should be on the same horizontal plane. In addition, it should be noted that there is a first protrusion structure P1 located at the joint of the first electrode connection portion 121 and the first electrode touching portion, and a second protrusion structure P2 located at the joint of the first electrode touching portion 122 and the first electrode extending portion 123 to enhance welding planeness. In the other embodiments, the first protrusion structure P1 can be regarded as the first electrode connection portion, the second protrusion structure P2 can be regarded as the first electrode extending portion, or the first electrode extending portion 123 of the first metal extending portion 12 may be omitted.

In addition, the second electrode metal plate includes a second frame portion (not shown) and a plurality of second metal extending portions (not shown). Each of the second metal extending portions is extended from the second frame portion and includes a second electrode connection portion (not shown), a second electrode touching portion (not shown), and a second electrode extending portion (not shown). The second electrode connection portion is connected to the second frame portion, the second electrode touching portion is connected to the second electrode connection portion, and the second electrode extending portion is connected to the second electrode touching portion. It should be noted that the edges of the first frame portion 11 and the second frame portion may have bended structures 111 to enhance the strength of the first electrode metal plate 1 and the second electrode metal plate.

After the step S101, the step S102 is carried out to provide a first frame and a second frame (not shown), have the first frame covering the first electrode metal plate 1 to form a first integrated battery core frame 100, and have the second frame covering the second electrode metal plate to form a second integrated battery core frame 200 (labeled in FIG. 7). Similarly, the second frame and the first frame are of the same structure and thus only the first frame is shown in the figures of the present invention. In addition, the first frame and the second frame are made of plastic material in the present embodiment, but the present invention is not so restricted.

In the present step S102, as shown in FIG. 2 to FIG. 4, an in-mold injection process is carried out to form the first frame body 21 and the first plate 22 on two sides of the first electrode metal plate 1, and the second frame body (not shown) and the second plate (not shown) on two sides of the second electrode metal plate. The in-mold injection process is a conventional manufacturing process and thus is not repeated here. It should be noted that the first frame and the second frame may be formed by using the in-mold injection process with an integrated mold or two separated molds. That is, the first frame body 21 and the first plate 22 may be formed as one piece or two pieces but connected with each other.

In addition, in accordance with a preferred embodiment of the present invention, the first frame body 21 includes a plurality of first battery core allocation portions 211. The first plate 22 is connected to the first frame body 21 and includes a plurality of first exposed portions 221 and a plurality of first conductor exposed portions 222. The first exposed portions 221 are arranged surrounding the first conductor exposed portions 222. The second frame body includes a plurality of second battery core allocation portions (not shown). The second plate is connected to the second frame body and includes a plurality of second exposed portions (not shown) and a plurality of second conductor exposed portions (not shown). The first conductor exposed portions 222 and the second conductor exposed portions may be utilized for placing the chip fuse or the conductive wire L, so as to prevent the conductor (e.g. the chip fuse M or the conductive wire L) with a height smaller than that of the first plate 22 from being rubbed by the external force.

Moreover, the first frame portion 11 is partially exposed from the plurality of the first exposed portions 221, and the plurality of the first metal extending portions 12 are exposed from the plurality of the first exposed portions 221 respectively. The second frame portion is exposed from the plurality of the second exposed portions, and the plurality of the second metal extending portions are exposed from the plurality of the second exposed portions respectively.

After the step S102, the step S103 is carried out to remove the first electrode connection portion 121 of the plurality of the first metal extending portions 12. Concretely speaking, because the first electrode is the positive electrode, in order to expand the opening size for dissipating the generated gas, a material cutting process is carried out in the step S103 to remove the first electrode connection portion 121. As shown, the first protrusion structure P1 is also removed in the present step, but the present invention is not so restricted. In accordance with the other embodiment of the present invention, the first protrusion structure P1 may be the only structure removed in the present step. It should be noted that, the removing step of the present embodiment is for separating the first electrode connection portion 121 and the first electrode touching portion 122, but not for totally removing the first electrode connection portion 121.

After the step S103, the step S104 is carried out to arrange a conductive wire L on the first frame portion 11 of the first electrode metal plate 1 and the first electrode extending portion 123 of the plurality of the first metal extending portions 12. The conductive wire L is a metal wire, such as an aluminum wire or a copper wire. As shown in FIG. 5, concretely speaking, because both the first frame portion 11 and the first electrode touching portions 122 are exposed to the external environment, it is capable to arrange the conductive wire L on the first frame portion 11 and the first electrode extending portions 123 by using the wire bonding, wire welding, or wire soldering process so as to have the first frame portion 11 connected to the first electrode extending portions 123 through the conductive wires L.

Thereafter, the step S105 is carried out to assemble a plurality of battery cores 3, a first integrated battery core frame 100, and a second integrated battery core frame 200. Concretely speaking, as shown in FIG. 7, the battery core 3 includes a first electrode 31 and a second electrode 32, the first electrode 31 is the positive electrode, and the second electrode 32 is the negative electrode. In the present step, these battery cores 3 are partially located in the plurality of the first electrode core allocation portions 211 and the plurality of the second battery core allocation portions, and have the first electrode 31 of the plurality of the battery cores 3 touching the first electrode touching portion 122 and have the second electrode 32 of the plurality of the battery cores 3 touching the second electrode touching portion. Afterward, at least two fixers 4 (four fixers are shown but only one is labeled in the figure) are connected to the first integrated battery core frame 100 and the second integrated battery core frame 200 (as shown, the fixers are connected to the side surfaces of the first frame body 21 and the second frame body) to fix the first integrated battery core frame 100 and the second integrated battery core frame 200. The fixers 4 may be formed of flexible material, and the fixers 4 may be connected to the first integrated battery core frame 100 and the second integrated battery core frame 200 by locking or screw-fixing (the method of locking is used in the present embodiment).

Finally, the step S106 is carried out to connect the first electrode touching portion 122 and the first electrode 31 of the plurality of the battery cores 3 by welding to have the first electrode touching portion 122 electrically connected to the first electrode 31. The welding technology is well known and thus is not repeated here.

It should be noted that, because the second electrode 32 is the negative electrode, it is not necessary to execute the material cutting process to remove the second electrode connection portion in the step S103 and the original second electrode connection portion may be used for electrically connecting the second frame portion 32. In other words, the only difference between the first integrated battery core frame 100 and the second integrated battery core frame 200 of the battery module 300 manufactured by using the above mentioned method is that, the first electrode connection portion 121 of the first integrated battery core frame 100 is removed and the conductive wire L is connected to increase the opening size for dissipating gas.

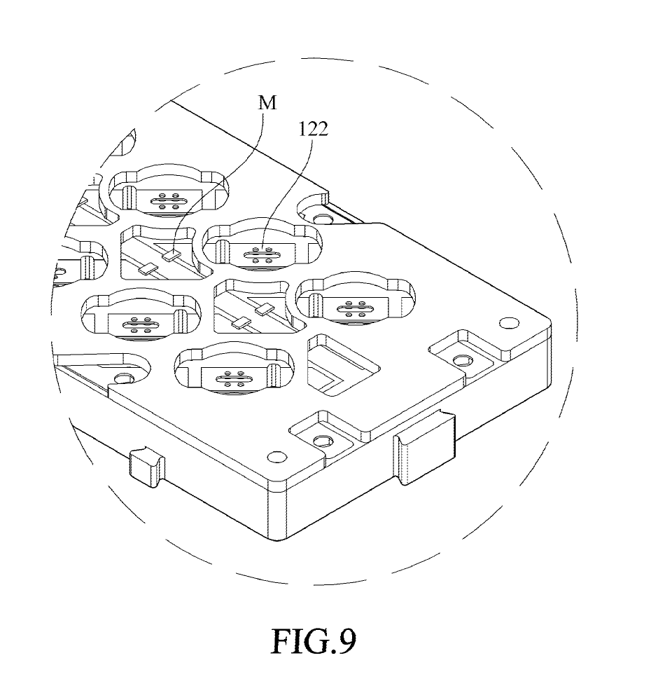

FIG. 9 is a 3D schematic view of the first frame portion and the first electrode extending portion with the chip fuse arranged thereon in accordance with another embodiment of the present invention. As shown, the only difference between the embodiment in FIG. 9 and the above mentioned preferred embodiment is to replace the conductive wire L with the chip fuse M. The other portions of the embodiment are identical to the above mentioned preferred embodiment and thus are not repeated here.

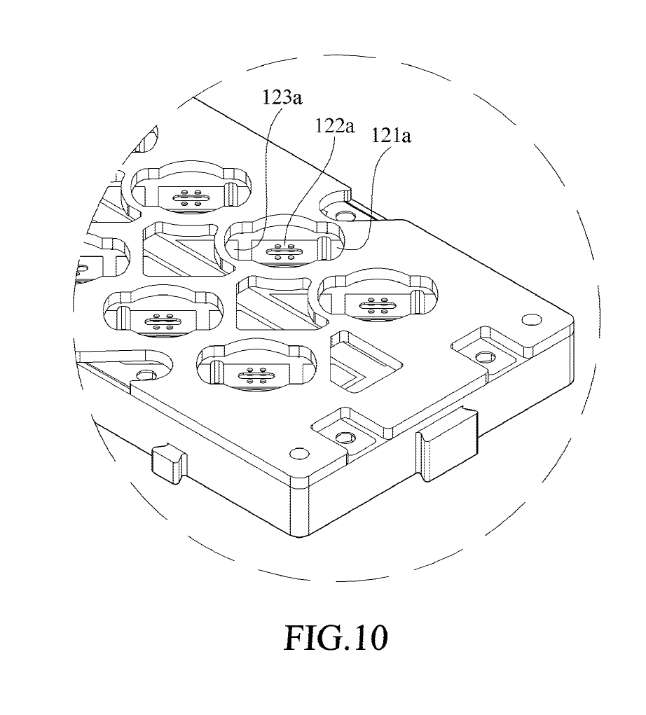

FIG. 10 is a 3D schematic view showing the first frame portion and the first metal extending portion with the first electrode extending portion being removed in accordance with another embodiment of the present invention. In compared with the above mentioned preferred embodiment, as shown in FIG. 10, the present embodiment removes the first electrode extending portion 123a (and also the second protrusion structure) in the step S103 rather than the first electrode connection portion 121a. Similar to the above mentioned preferred embodiment, the removing step is for separating the first electrode extending portion 123a and the first electrode touching portion 122a but not for totally removing the first electrode extending portion 123a. In addition, the present embodiment skips the step S104 after the first electrode extending portion 123a is removed. The step S105 and the following step S106 are executed right after the first electrode extending portion 123a is removed. The present embodiment may enhance flexibility of the manufacturing method in practice. For example, the negative electrode portion of the battery module may be manufactured by using the manufacturing method of the present embodiment, and the positive electrode portion may be manufactured by using the manufacturing method of the preferred embodiment. But the present invention is not so restricted.

In conclusion, by using the manufacturing method of the battery module provided in the present invention, the two identical electrode metal plates applied to the positive electrode or the negative electrode of the battery core 3 may be formed by using the same mold, and a portion of the electrode connection end at the positive electrode is further removed to assemble the battery module 300. Thus, the manufacturing cost of the battery module 300 can be significantly reduced by using the technology provided in the present invention.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A manufacturing method of battery module, utilized for manufacturing a batter module, comprising the steps of:
(a) forming a first electrode metal plate and a second electrode metal plate by punching, the first electrode metal plate including a first frame portion and a plurality of first metal extending portions, each of the first metal extending portions being extended from the first frame portion and including a first electrode connecting portion and a first electrode touching portion, wherein the first electrode connecting portion is connected to the first frame portion, and the first electrode touching portion is connected to the first electrode connecting portion; and the second electrode metal plate including a second frame portion and a plurality of second metal extending portions, each of the second metal extending portions being extended from the second frame portion and including a second electrode connecting portion and a second electrode touching portion, wherein the second electrode connecting portion is connected to the second frame portion, and the second electrode touching portion is connected to the second electrode connecting portion;
(b) providing a first frame and a second frame, having the first frame covering the first electrode metal plate to form a first integrated battery core frame and having the second frame covering the second electrode metal plate to form a second integrated battery bore frame, the first frame including a plurality of first battery core allocation portions and a plurality of first exposed portions, the first frame portion being exposed from the plurality of the first exposed portions, and the plurality of the first metal extending portions being exposed from the plurality of the first exposed portions respectively, the second frame including a plurality of second battery core allocation portions and a plurality of second exposed portions, the second frame portion being exposed from the plurality of the second exposed portions and the second extending portions being exposed from the plurality of the second exposed portions respectively;
(c) removing the first electrode connection portion or a first electrode extending portion of the first metal extending portion;
(d) when the first electrode connection portion is removed in the step (c), arranging a conductive wire or a chip fuse on the first frame portion and the first electrode extending portion of the first metal extending portion to have the first frame portion connected to the first electrode extending portion;
(e) assembling a plurality of battery cores, the first integrated battery core frame, and the second integrated battery core frame to have the plurality of the battery cores located in the plurality of the first battery core allocation portions and the plurality of the second battery core allocation portions respectively and have a first electrode of the plurality of the battery cores touching the first electrode touching portion and have a second electrode of the plurality of the battery cores touching the second electrode touching portion; and
(f) connecting the first electrode touching portion and the first electrode of the plurality of the battery cores by welding to have the first electrode touching portion electrically connected to the first electrode;
wherein the first electrode metal plate and the second electrode metal plate are of the same structure, and the first frame and the second frame are of the same structure;
wherein when the first electrode extending portion is removed in the step (c), the step (d) is skipped.

2. The manufacturing method of battery module of claim 1, wherein in the step (a), the first electrode touching portion is further connected to the first electrode extending portion, and in the step (e), the first electrode extending portion is removed.

3. The manufacturing method of battery module of claim 1, wherein the first frame comprises a first frame body and a first plate, the first frame body includes the plurality of the first battery core allocation portions, the first plate is connected to the first frame body and includes the plurality of the first exposed portions, the second frame comprises a second frame body and a second plate, the second frame body includes the plurality of the second battery core allocation portions, the second plate is connected to the second frame body and includes the plurality of the second exposed portions, and in the step (b), an in-mold injection process is carried out to form the first frame body and the first plate on two sides of the first electrode metal plate, and form the second frame body and the second plate on two sides of the second electrode metal plate.

4. The manufacturing method of battery module of claim 1, wherein the first frame and the second frame are made of plastic material.

5. The manufacturing method of battery module of claim 1, wherein the conductive wire is a metal wire.

6. The manufacturing method of battery module of claim 1, wherein the first electrode is a positive electrode and the second electrode is a negative electrode.

7. The manufacturing method of battery module of claim 1, wherein the step (e) uses at least two fixers connected to the first integrated battery core frame and the second integrate battery core frame to fix the first integrated battery core frame and the second integrated battery core frame.

8. A battery module, comprising:
a first integrated battery core frame, including:
a first frame, including:
a plurality of first battery core allocation portions; and
a plurality of first exposed portions, connected to the plurality
of the first battery core allocation portions; and
a first electrode metal plate, covered by the first frame, and including:
a first frame portion, exposed from the plurality of the first exposed portions; and
a plurality of first metal extending portions, each of the first metal extending portions being extended from the first frame portion, exposed from the plurality of the first exposed portions respectively, and including a first electrode touching portion and a first electrode extending portion, and the first electrode extending portion being electrically connected to the first frame portion through a conductive wire or a chip fuse;
a second integrated battery core frame, including:
a second frame, including:
a plurality of second battery core allocation portions; and
a plurality of second exposed portions, connected to the plurality of the second battery core allocation portions; and
a second electrode metal plate, covered by the second frame, and including:
a second frame portion, exposed from the plurality of the second exposed portions; and
a plurality of second metal extending portions, each of the second metal extending portions being extended from the second frame portion, exposed from the plurality of the second exposed portions respectively, and including a second electrode connection portion and a second electrode touching portion, and the second electrode connection portion being connected to the second frame portion and the second electrode touching portion being connected to the second electrode connection portion; and
a plurality of battery cores, partially located in the plurality of the first battery core allocation portions and the plurality of the second battery core allocation portions, a first electrode of the plurality of the battery cores touching the first electrode touching portion of the plurality of the first metal extending portions, and a second electrode of the plurality of the battery cores touching the plurality of the second electrode touching portions;
wherein, the first electrode metal plate and the second electrode metal plate are of the same structure, and the first frame and the second frame are of the same structure.

9. The battery module of claim 8, wherein the first frame comprises a first frame body and a first plate, the first frame body includes the plurality of the first battery core allocation portions, the first plate is connected to the first frame body and includes the plurality of the first exposed portions, the second frame comprises a second frame body and a second plate, the second frame body includes the plurality of the second battery core allocation portions, the second plate is connected to the second frame body and includes the plurality of the second exposed portions.

10. The battery module of claim 8, wherein the first frame and the second frame are made of plastic material.

11. The battery module of claim 8, wherein the conductive wire is a metal wire.

12. The battery module of claim 8, further comprising at least two fixers, connected to the first integrated battery core frame and the second integrated battery core frame for fixing the first integrated battery core frame and the second integrated battery core frame.

13. The battery module of claim 8, wherein the first electrode is a positive electrode and the second electrode is a negative electrode.
